(19) United States
(12) Patent Application Publication
(10) Pub. No.: US 2023/0090956 A1
(43) Pub. Date: Mar. 23, 2023

(54) AIR RIDE FLOOR ASSEMBLY

(71) Applicant: Lane L. English, Texarkana, TX (US)

(72) Inventor: Lane L. English, Texarkana, TX (US)

(21) Appl. No.: 17/483,615

(22) Filed: Sep. 23, 2021

(51) Int. Cl. F16F 15/027; F16F 15/023

(52) U.S. Cl. CPC F16F 15/027; F16F 15/0232

(57) ABSTRACT

A floor assembly includes a controller, a compressor, an airbag, and a floor. The controller is configured to provide one or more user controls to permit a user to operate the compressor and regulate pressure in the airbags. The floating floor is configured to isolate a carrying load from vibrational effects and trailer forces. The assembly is optionally removable from a trailer floor and may be inserted on a different trailer. A guide member is used to restrict movement of the floor on the airbags to only a vertical motion. The guide members may include a dampener.

### BACKGROUND OF THE INVENTION

### 1. Field of the Invention

The present application relates to a trailer, and more particularly to a floor dampening unit within a trailer to reduce vibrational effects.

### 2. Description of Related Art

Trailers are commonly used by the public for personal, commercial, and industrial uses. There are many types of trailers and various ways to connect them to a pulling vehicle. A trailer is designed to generally carry a load behind a pulling vehicle. Trailers have a flat surface in which to load objects. The weight of these objects are supported by the trailer frame and are “cushioned” by mechanical leaf springs between the floor of the trailer and the axle. Usually shocks are not include on trailers. It is relatively known that the ride quality in the back of a trailer can be fairly rough and uncomfortable. While typically this does not matter so much, especially in instances when the load carried is an object, such ride quality may matter when the load carried is alive.

Trailers are commonly used to carry live animals. The animals are oriented and packed into the trailers in a manner that is most efficient for the operator. Usually the goal is to place them in the trailer in the least amount of space necessary to enable one to carry more animals. The animals, as seen with large livestock especially, are typically required to stand while in the trailer. Not a lot of room is generally left for animals to move about and lie down. An animal that lies down can cause injury to itself by being stepped on or can hurt other animals.

The level of fatigue that an animal is exposed to in a trailer is real. To reduce fatigue, efforts have been made to coat the floor of the trailer with mats to cushion the feet of the animal. While providing some assistance, the animal is still left to absorb a great amount of vibration and forces from ill tuned trailer suspensions. Trailer suspensions provide minimal comfort for vibrations transmitted to the livestock.

Although strides have been made, shortcomings remain. It is desired that an assembly be provided that is configured to minimize and isolate vibrations and forces between the trailer and the animal being carried.

### BRIEF SUMMARY OF THE INVENTION

It is an object of the present application to provide an air ride floor assembly that is located in a trailer to isolate floor vibrations and forces between the trailer and any cargo being carried, whether living cargo or inanimate cargo. It is desired that the floor assembly be incorporated within the trailer as a whole unit or is provided alternatively as a separate retrofit option for existing trailers.

It is a further object of the present application that a floor is suspended above the frame of the trailer via pneumatic air pressure via one or more airbags. The assembly may also include one or more shocks to dampen any movements of the airbags.

Another object of the present application is to permit the airbags to be collectively regulated through one or more compressors and a control unit. The pressure in the airbags may be adjusted by adding or removing air. A user is able to engage one or more controls to activate a compressor. Each airbag may be isolated for individual control and/or all airbags may be regulated collectively.

Wherein the floor assembly is a retrofit unit, the floor may be added and removed to a trailer. Additionally, the floor assembly is ideally suited to cover the entire floor, however, some uses may prefer to restrict the size so as to be smaller than the floor size of the trailer.

Ultimately the invention may take many embodiments. In these ways, the present invention overcomes the disadvantages inherent in the prior art. The more important features have thus been outlined in order that the more detailed description that follows may be better understood and to ensure that the present contribution to the art is appreciated. Additional features will be described hereinafter and will form the subject matter of the claims that follow.

Many objects of the present application will appear from the following description and appended claims, reference being made to the accompanying drawings forming a part of this specification wherein like reference characters designate corresponding parts in the several views.

Before explaining at least one embodiment of the present invention in detail, it is to be understood that the embodiments are not limited in its application to the details of construction and the arrangements of the components set forth in the following description or illustrated in the drawings. The embodiments are capable of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the various purposes of the present design. It is important, therefore, that the claims be regarded as including such equivalent constructions insofar as they do not depart from the spirit and scope of the present application.

### BRIEF DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a side view of an air ride floor assembly according to an embodiment of the present application.

FIG. 2 is an enlarged side view of the air ride floor assembly of FIG. 1.

FIG. 3 is a top view of the air ride floor assembly of FIG. 2.

FIG. 4 is a bottom view of the air ride floor assembly of FIG. 2.

While the embodiments and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE INVENTION

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the embodiments described herein may be oriented in any desired direction.

The embodiments and method in accordance with the present application overcomes one or more of the above-discussed problems commonly associated with the prior art discussed previously. In particular, the air ride floor assembly is configured to isolate the floor from vibrations originating from the trailer frame and suspension. These and other unique features are discussed below and illustrated in the accompanying drawings.

The embodiments and method will be understood, both as to its structure and operation, from the accompanying drawings, taken in conjunction with the accompanying description. Several embodiments of the assembly may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

The embodiments and method of the present application is illustrated in the associated drawings. The floor assembly includes one or more airbags located beneath a floor. The airbags absorb vibrations to isolate the floor. A guide member is used to restrict motion of the floor to that being in a vertical movement. A controller is used in combination with a compressor to regulate air pressure within the airbag. In units that are removable from the trailer, the floor assembly may also include a base unit beneath the airbag. This allows the assembly to be removable. Additional features and functions are illustrated and discussed below.

Referring now to the Figures wherein like reference characters identify corresponding or similar elements in form and function throughout the several views. The following Figures describe embodiments of the present application and its associated features. With reference now to the Figures, embodiments of the present application are herein described. It should be noted that the articles “a”, “an”, and “the”, as used in this specification, include plural referents unless the content clearly dictates otherwise.

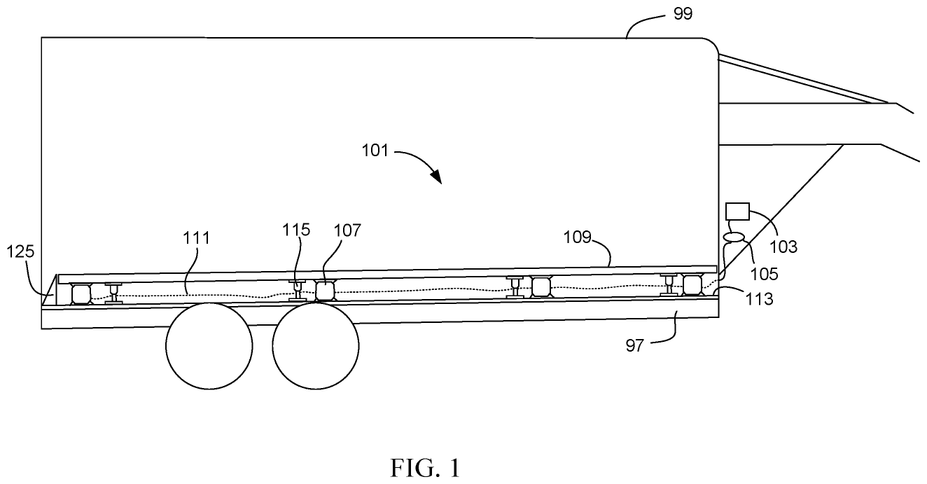

Referring now to FIG. 1 in the drawings, a side view of the air ride floor assembly 101 is illustrated. In this embodiment, assembly 101 is located within a cattle trailer 99 having an existing floor 97. It should be understood that floor assembly 101 may be built within a trailer in some embodiments such that it replaces floor 97. Alternatively, floor assembly 101 may be configured to operate as a removable unit that rests on floor 97. Discussion on this feature will be seen below.

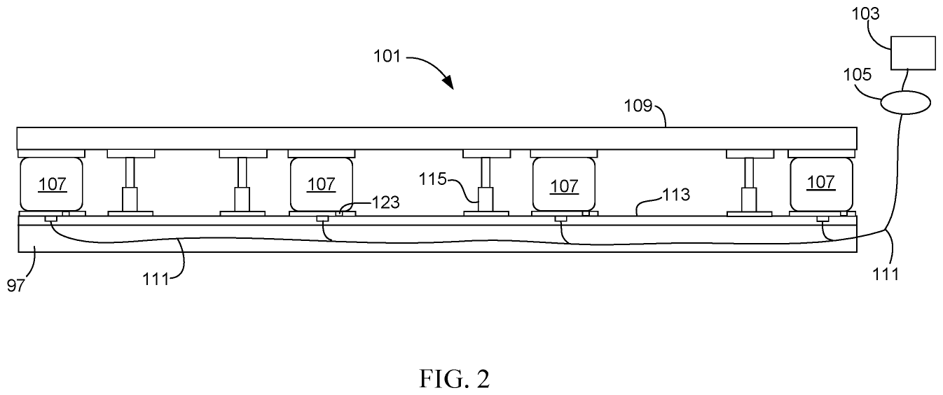

Referring now also to FIG. 2 in the drawings, an enlarged side view of assembly 101 from FIG. 1 is shown. Floor assembly 101 includes a controller 103, a compressor 105, an airbag 107, and a floor 109. Controller 103 is configured to provide one or more user controls to permit a user to operate assembly 101 by regulating the pressure in airbag 107. The controls may be electronic, touch screen, or simple mechanical.

Controller 103 is in electrical communication with compressor 105 and is configured to run or operate compressor 105. Controller 103 may turn compressor on/off and regulate the discharge of air pressure through one or more lines 111. The lines run from compressor 105 to the one or more airbags 107. As described, assembly 101 is operable with pneumatic air pressure, however, other forms of liquids are permitted and their adoption and use may be dependent upon design criteria. Controller 103 and compressor 105 are coupled to a portion of the trailer 99 and may be powered by an external battery or through the pulling vehicle itself. Compressor 105 and controller 103 may be removed from trailer 99.

Airbag 107 is coupled to a lower portion of floor 109. As seen in FIGS. 1 and 2, airbag 107 rests upon a base unit 113. This is merely exemplary for purposes of discussion herein. Base unit 113 is optionally used. In embodiments wherein assembly 101 is built into the trailer, base unit 113 may be removed or not used as the subframe and/or existing flooring 97 of the trailer 99 can provide support for the airbags 107. However, in embodiments wherein assembly 101 is a standalone unit, conditions may exist wherein assembly 101 is removable from trailer 99 and may be located outside a trailer for operation or on a different trailer. In such an embodiment, base unit 113 may be used to ensure a proper subfloor to support airbags 107. In any embodiment, it is understood that base unit 113 is optional only.

The purpose of airbags 107 is to minimize the vibrational effects and load forces exerted upon and by trailer 99 and floor 109. This is extremely useful when the carried load is livestock. This assists in drastically decreasing fatigue on the animals and can assist in preventing injuries. As shown a plurality of airbags 107 are used. The air pressure in each airbag 107 may be regulated independent of the other airbags or in combination with the other airbags as a collective whole. One or more lines 111 may be used to accomplish this feature.

Assembly 101 may further include one or more guide members 115 configured to partially restrict the movement of floor 109 on the airbags 107. Guide members 115 are coupled to a lower portion of the floor 109 and may also be coupled to an upper portion of base unit 113 when used. As airbags 107 are cushions of air, a tendency may be realized wherein floor 109 may want to move laterally. Floor 109 is configured to move independent of trailer 99 and its side walls. Floor 109 is not required to be in contact with any walls of trailer 99. In order to alleviate or stop lateral movements of floor 109 which may result in undesired contact with trailer 99, guide members 115 are included. Guide members 115 are configured to permit vertical translation of floor 109 but not lateral translation. Guide members 115 include telescoping cylinders in this embodiment to facilitate this function. Other embodiments are possible. It should be stated that guide members 115 may include a dampener configured to slow or stop bouncing effects from airbags 107. In this way, guide members 115 may be a shock absorber.

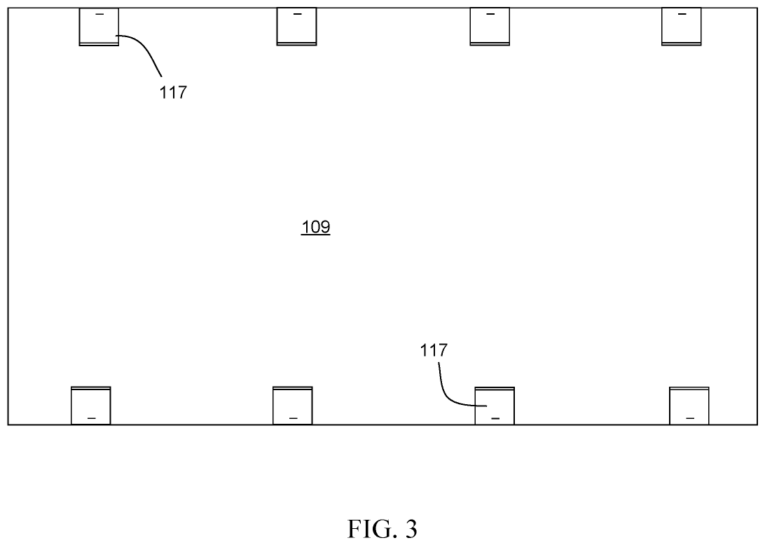

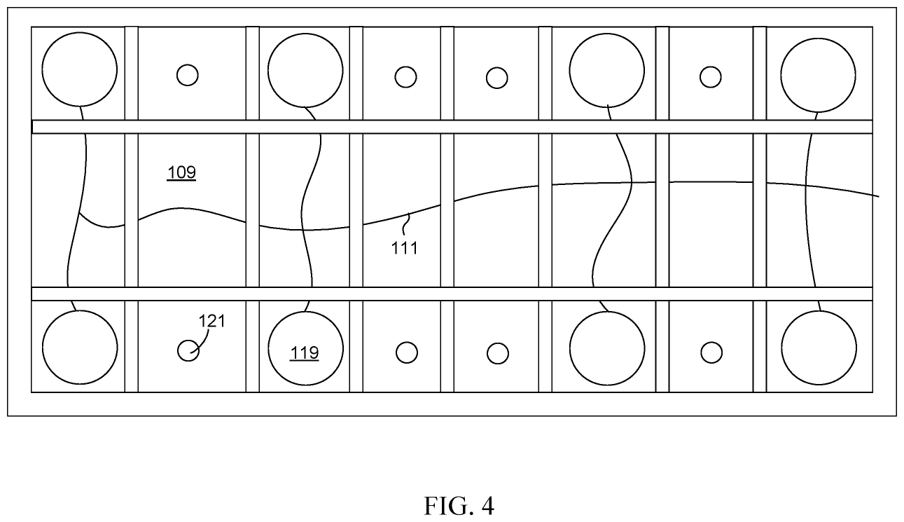

Referring now also to FIGS. 3 and 4 in the drawings, a top and bottom view of assembly 101 is provided. Floor 109 is not restricted in size or shape and may be made in any size and shape necessary. Assembly 101 may include a door assembly 117 in floor 109 to permit a user access below the floor and specifically to airbags 107. The door assemblies are hinged on one end and a handle is used to rotate a door. One or more doors may be used. As the distance between floor 109 and base unit 113 (or floor 97) is ideally minimal, it is generally conceived that a single door assembly 117 may not be sufficient on its own to allow a user access to each airbag 107 if such airbags 107 are dispersed over a large area.

As seen in particular in FIG. 4, base unit 113 is not shown. Lines 111 may be routed through a subframe assembly to each airbag (not shown). The assembly 101 may include plates 119 which are used to support airbags 107. Corresponding plates may be seen with guide members 115.

During operation, a user may operate controller 103 to regulate performance of compressor 105 which in turn adjusts the pressure in airbags 107. Controller 103 may also be configured to include sensors 123 to read and therefore display air pressure status for each airbag or collectively. The floor assembly may be removed or inserted into any appropriately sized trailer. The air pressure may be adjusted once the load is determined. Adjusting the air pressure differently between the airbags may be needed depending on the load distribution on floor 109.

It should be noted that assembly 101 may include a barrier 125 at a rear portion of the assembly that is configured to block access under floor 109. Barrier 125 may be attached to base unit 113 or floor 97 depending on configuration.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A floor assembly, comprising:
a controller;
a compressor in communication with the controller, the controller regulating performance of the compressor;
an airbag in communication with the compressor, the airbag configured to receive air from the compressor so as to regulate air pressure within the airbag;
a floor resting on the airbag so as to elevate the floor; and
a guide member coupled to a lower portion of the floor and configured to restrict motion of the floor to be within a vertical direction.

2. The assembly of claim 1, wherein the controller includes a sensor to read and display air pressure in the airbag.

3. The assembly of claim 1, further comprising:
a second airbag, the second airbag in communication with the compressor for regulating air pressure in the second airbag.

4. The assembly of claim 3, wherein the air pressure in the first airbag and the air pressure in the second airbag is adjusted simultaneously.

5. The assembly of claim 3, wherein the air pressure in the first airbag and the air pressure in the second airbag is adjusted individually independent of the other.

6. The assembly of claim 1, wherein the guide member includes a dampener.

7. The assembly of claim 1, further comprising:
a door assembly along an upper surface of the floor, the door assembly configure to provide access to the airbag.

8. A floor assembly, comprising:
a controller;
a compressor in communication with the controller, the controller regulating performance of the compressor;
a plurality of airbags in communication with the compressor, the plurality of airbags being configured to receive air from the compressor so as to regulate air pressure within the plurality of airbags;
a floor resting on the plurality of airbags so as to elevate the floor; and
a guide member coupled to a lower portion of the floor and configured to restrict motion of the floor to be within a vertical direction.

9. The assembly of claim 8, wherein the compressor is pneumatic.

10. The assembly of claim 8, wherein the air pressure in a first airbag and a second airbag of the plurality of airbags is adjusted simultaneously.

11. The assembly of claim 8, wherein the air pressure in a first airbag and a second airbag of the plurality of airbags is adjusted individually independent of the another.

12. The assembly of claim 8, wherein the guide member includes a shock absorber.

13. The assembly of claim 8, further comprising:
a door assembly along an upper surface of the floor, the door assembly configured to provide access to the plurality of airbags.

14. The assembly of claim 8, further comprising:
a base unit for supporting at least one of the guide members and the plurality of airbags.

15. A method of minimizing floor vibrations in a trailer, comprising:
obtaining a floor assembly of claim 8;
operating a controller to regulate a level of air pressure in the plurality of airbags; and
locating the floor assembly on a surface in the trailer.

16. The method of claim 15, further comprising:
removing the floor assembly from the trailer as a single unit.

17. The method of claim 15, further comprising:
changing the air pressure in the plurality of airbags independently from another airbag.

18. The method of claim 15, further comprising:
changing the air pressure collectively with the plurality of airbags.

19. The method of claim 15, further comprising:
operating a door assembly along the floor to gain access to the plurality of airbags beneath the floor.
